(19) United States
(12) Patent Application Publication
(10) Pub. No.: US 2006/0001235 A1
(43) Pub. Date: Jan. 5, 2006

(54) Deployable training wheels apparatus for a motorized vehicle

(76) Inventor: Dao Hoang, Austin, TX (US)

Correspondence Address: Dao Hoang, 1913 Vallejo St, Austin, TX, 78757, US

(21) Appl. No.: 10/880,727

(22) Filed: Jun. 30, 2004

(51) Int. Cl. B62K 1/00

(52) U.S. Cl. 280/283

(57) ABSTRACT

Disclosed is a deployable training wheels apparatus for a vehicle having a front major wheel, a rear major wheel and a supporting means. The vehicle may also comprise a footbar attached with the supporting means. The invention comprises a hollow coupler having two ends; two axles, each axle having a proximal end and a distal end; the distal end of each axle removably inserted into an end of the coupling means and the axle removably secured within the coupler by a fastener; the proximal end of each axle rotatably attached with a wheel assembly; and the coupler removably fastened to the vehicle supporting means, directly or by attachment to the footbar, such that the wheels are disposed in parallel relation to the major wheels. Also disclosed is a kit for use with a vehicle having a front major wheel, a rear major wheel, and a supporting means, comprising a hollow coupler having two ends; two axles, each axle having a proximal end and a distal end; the coupler having an inner dimension sufficient for receiving the distal end of an axle at each end of the coupler; at least two fasteners for securing the axles within the coupler; two wheel assemblies; means for rotatably attaching the wheel assemblies with the axles; and at least two bolts for removably attaching the coupler with the vehicle supporting means, directly or by attachment with the footbar, such that the wheel assemblies are disposed in parallel relation to the major wheels.

### BACKGROUND OF THE INVENTION

1. Field of the Invention

The invention is directed generally to means for training individuals in balancing and riding engine-powered motorcycles and motorbikes. More specifically, the invention is directed to a deployable training wheels apparatus for a motorcycle or motorbike.

2. Description of Related Art

Engine-powered motorcycles and motorbikes provide an easy means of transportation, when compared with conventional bicycles. The power of an engine allows individuals to transport themselves at normal traffic speeds while suffering minimal effects from steep grades. Engine-powered vehicles also provide a means of recreation, as certain models are adapted for off-road travel, sport racing and other entertaining activities.

In recent years, it has become commonplace for children to take up riding motorcycles and motorbikes as a sport or hobby. However, children and some adult riders often have difficulty developing balance and control over the vehicle. For instance, when the vehicle is at rest, most children's legs are too short to contact the ground on both sides of the vehicle, and the vehicle's weight prevents them from supporting the motorcycle on one leg by tipping it to either side. Additionally, when the vehicle is in motion, particularly at low speeds, a slight lapse in balance or steering can elicit a drastic and often unrecoverable loss of control.

In addition to the weight of a motorcycle or motorbike, the speed at which engine-powered cycles travel increases the risk of injury over conventional bicycles. This makes it dangerous to teach balance and control through trial and error, and it prohibits the interference of another person, such as a person running along side and steadying the bike until the rider is comfortable. Hence, an effective means for assisting the rider must be contained within the vehicle itself.

Past inventions have integrated a training apparatus within an engine-powered motorcycle or motorbike. One such invention is described in U.S. Pat. No. 4,826,194 to Sakita. Sakita discloses a side-wheel assembly for a motorcycle, which comprises an arm extending from a connecting shaft to an axle on each side of the motorcycle. When in an unlocked position, wheels on each axle turn, supporting the motorcycle during operation. Though effective, the Sakita apparatus is not readily removable from the motorcycle. The connecting shaft's bearings are secured to the motorcycle frame by welding, clamping or permanent means. The arms are, in turn, fixed permanently to the connecting shaft. This design forces a rider to spend a great deal of time and money removing the apparatus when it is no longer needed, and repairing or refinishing any parts of the motorcycle where welds have been removed. Alternatively, the rider must purchase a completely different motorcycle or motorbike that does not possess the integrated Sakita apparatus.

Latter inventions have improved upon Sakita, by providing removable training apparatus for standard motorcycle or motorbike designs. For example, U.S. Pat. No. 6,296,266 to Martin discloses a removable apparatus, wherein connectors are inserted between a motorcycle's frame and footpeg, on each side of the motorcycle. The connectors extend to a single-axle having wheels on either end. This design allows removability of the training wheels apparatus when it is no longer needed, but it also limits application of the invention. A single-axles design is not applicable to all vehicles, because the distance of the wheels from the vehicle may need to be lengthened or shortened to increase or decrease turning radius, to accommodate the height of the rider, or to prevent teetering on straightaways. Additionally, the invention is only applicable to motorcycles and motorbikes having or accommodating removable footpegs, and the footpegs are moved a few inches outside of their normal position when using the Martin invention. This widening of the footpeg positions can make riding uncomfortable for children. Finally, attaching and removing the apparatus requires a significant amount of time, due to its unitary construction, and the footpegs of the motorcycle must be detached before the training apparatus may be attached or removed. As a result, transport and storage of the vehicle requires a great deal of time and disassembly, and riders cannot be spot-tested on their readiness to operate the vehicle without the training wheels apparatus.

Hence, there is a great need in the art for a training wheels apparatus that is readily applicable to motorcycles and motorbikes of varying designs and dimensions. The distance of the training wheels from the motorcycle must be readily adjustable. The apparatus must be attachable to a vehicle without dependence upon connective means provided on the vehicle itself. The invention must also be readily deployable, such that the training wheels may be quickly removed from the motorcycle without tools, without shutting the motorcycle engine off, and without removing any parts from the motorcycle.

### SUMMARY OF THE INVENTION

The current invention is directed to a deployable training wheels apparatus for motorized vehicles. The invention is readily applicable to motorcycles and motorbikes of varying designs and dimensions, by allowing the distance of the training wheels from the motorcycle to be readily adjusted. The apparatus may be attached to a vehicle without dependence upon connective means provided on the vehicle itself. The invention may also be quickly removed from the motorcycle without tools, without shutting the motorcycle engine off, and without removing any parts from the motorcycle.

The deployable training wheels apparatus of the current invention is for use with a vehicle having a front major wheel, a rear major wheel, and a supporting means. The vehicle may also comprise a footbar attached with the supporting means. The invented apparatus comprises a hollow coupler having two ends and two axles, each axle having a proximal end and a distal end. The distal end of each axle is removably inserted into an end of the coupling means and the axle is removably secured within the coupler by a fastener. The proximal end of each axle rotatably attached with a wheel assembly, and the coupler is removably fastened to the vehicle supporting means, directly or by attachment to the footbar, such that the wheels are disposed in parallel relation to the major wheels.

The deployable training wheels apparatus may be used with a vehicle supporting means that comprises a vehicle frame or a vehicle engine casing. The coupler may further comprise a connector plate for attaching coupler to the vehicle frame or engine casing. The apparatus may be formed such that each axle may be secured within the coupler only at a single position or at multiple positions.

The coupler of the deployable training wheels apparatus may further comprise at least one pair of coupler holes, each pair of coupler holes penetrating a surface of the coupler. Each axle may further comprise at least one axle hole having a centerpoint that penetrates the diameter of the axle. The axles are removably secured within the coupler by aligning coupler holes with the axle holes and inserting a fastener through each coupler hole and the axle holes aligned with that coupler hole.

The current invention is also directed to a kit for use with a vehicle having a front major wheel, a rear major wheel, and a supporting means. The vehicle may also comprise a footbar attached with the supporting means. The kit comprises two axles and a hollow coupler having two ends. Each axle has a proximal end and a distal end, and the coupler has an inner dimension sufficient for receiving the distal end of an axle at each end of the coupler. The kit also comprises at least two fasteners for removably securing the axles within the coupler. The kit also comprises two wheel assemblies and means for rotatably attaching the wheel assemblies with the axles. The kit also comprises at least two bolts for removably attaching the coupler with the vehicle supporting means, directly or by attachment with the footbar, such that the wheel assemblies are disposed in parallel relation to the major wheels.

The kit may be used with vehicles whose supporting means comprise vehicle frames or engine casings. The coupler may also comprise a connector plate for attaching the coupler to the vehicle frame or engine casing. The coupler and axles included in the kit may be susceptible of attachment at single or multiple positions.

The current invention provides advantages over prior training wheels apparatuses by providing a means for removable attachment to a motorcycle frame, without regard to the connective means used for ancillary parts already integrated with the motorcycle. The invention also provides a pair of independent training wheels that are coupled to each other, rather than a unitary frame structure. This allows easier adaptation of the apparatus to motorcycles and motorbikes requiring the training wheels to be closer to or further away from each other, than with motorcycles of other sizes. Rather than reforming the entire frame of the training wheels apparatus, a longer or shorter coupler may be used, a standard coupler may be provided with many positions for coupling the independent axles, or the independent axles may be shortened. These and other advantages will be readily apparent from the detailed description below.

### BRIEF DESCRIPTION OF THE DRAWINGS

FIG. 1 is a diagram illustrating an angled perspective view of a removable training wheels apparatus, in accordance with one embodiment of the present invention.

FIG. 2 is a diagram illustrating a bottom perspective view of the apparatus shown in FIG. 1, as it is attached to the frame of a motorcycle or motorbike.

FIG. 3 is a diagram illustrating an angled perspective view of a removable training wheels apparatus, in accordance with a second embodiment of the present invention.

FIG. 4 is a diagram illustrating a bottom perspective view of the apparatus shown in FIG. 3, as it is attached to the engine casing of a motorcycle or motorbike.

FIG. 5 is a diagram illustrating a bottom perspective view of the apparatus shown in FIG. 3, as it is attached to the frame of a motorcycle or motorbike.

### DETAILED DESCRIPTION

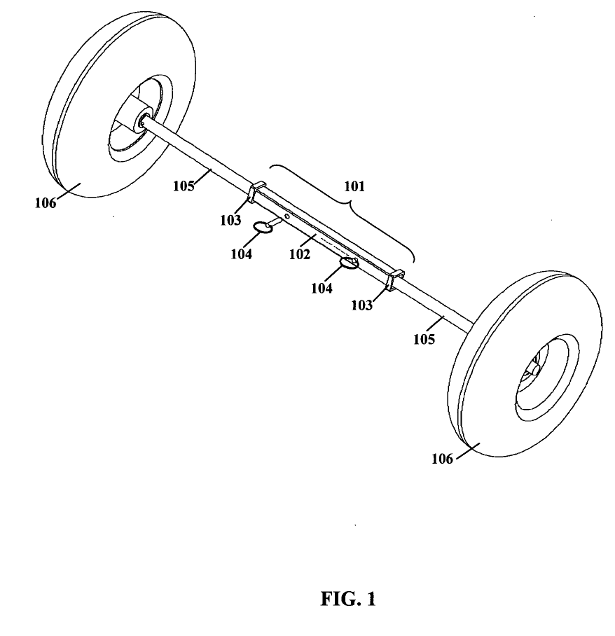

Now referring to the drawings, wherein like features are designated by like numbers, the invention is directed to a deployable training wheels apparatus for a motorized vehicle. FIG. 1 illustrates an angled perspective view of one embodiment of the invention, which is for use with motorcycles and motorbikes having a frame that supports the engine of the vehicle. The invention comprises a coupler 101 having an elongated portion 102 and enlarged ends 103. The elongated portion 102 of coupler 101 may be cylindrical, or it may have rectangular sides. A first pair of holes penetrate a surface of elongated portion 102, at equal distances from ends 103. Each hole has dimensions suited for receiving a fastener 104. A second pair of holes penetrate a surface of elongated portion 102 directly opposite and aligned with the first pair. Where coupler 101 is cylindrical, the centerpoints of the holes lie along the diameter of the cylinder. Where coupler 101 has rectangular sides, the first pair of holes and second pair of holes are aligned on parallel surfaces of coupler 101.

Coupler 101 is hollow and has an inner dimension suitable for receiving an axle 105 at each end 103. Preferably, axles 105 fit tightly within coupler 101, such that coupler 101 and axles 105 remain at a zero degree (0°) angle with one another during operation of the invention. Each axle 105 has a distal end that is received by coupler 101 and a proximal end that is rotatably attached with a wheel assembly 106. Each axle 105 also contains at least one hole for receiving a fastener 104. Axles 105 are fixed within coupler 101 by aligning a hole on each axle 105 with a hole of coupler 101, and then inserting fasteners 104 into the first pair of holes on coupler 101, through the holes on axles 105, and out the second pair of holes on coupler 101. Fasteners 104 provide substantial resistance to removal once they are inserted, such that vibration will not shake them loose. Fasteners 104 may be suitable for use with cotter pins; they may comprise detent pins or pop-pins; or they may comprise any other suitable fastener that may be removed manually, but not by disturbances caused by riding the vehicle. Preferably, fasteners 104 comprise detent pins attached with rings or knobs that facilitate removal.

Elongated portion 102 may have a tapering inner dimension, such that progress of an axle 105 into coupler 101 stops when a hole of the axle 106 is at a position to be aligned with the nearest hole of coupler 101. The ends 103 of coupler 101 may be cylindrical or may have rectangular sides. The shape of ends 103 need not match that of elongated portion 102, even though coupler 101 is preferably of unitary construction. Coupler 101 and axles 105 may be formed from any sturdy material that will not bend when the weight of the vehicle is applied to either wheel assembly 106. They should also be rust-resistant. Preferably, coupler 101 and axles 105 are formed of stainless steel or carbon steel.

As stated previously, coupler 101 may have more than one pair holes. Holes may be placed on a single surface of coupler 101, in pairs that are spaced at equal distances from the ends 103 of coupler 101. In this way, coupler 101 may be coupled with axles 105 at multiple positions. Each coupling position lengthens or shortens the extension of axles 105 beyond coupler 101, and hence, beyond the width of the vehicle. Alternatively, each axle 105 may contain more than one hole at evenly spaced distances from its distal end. In this way, the extension of the axles 105 beyond coupler 101 is determined by which holes on axles 106 are aligned with a single pair of holes on coupler 101. Alternatively, coupler 101 may have more than one pair of holes and axles 105 may each have more than one hole. Preferably, coupler 101 contains more than one pair of holes, and each axle 105 contains one hole, such that the distance of each wheel assembly 106 from the vehicle depends upon which pair of holes on coupler 101 are fastened with the hole on each axle 105.

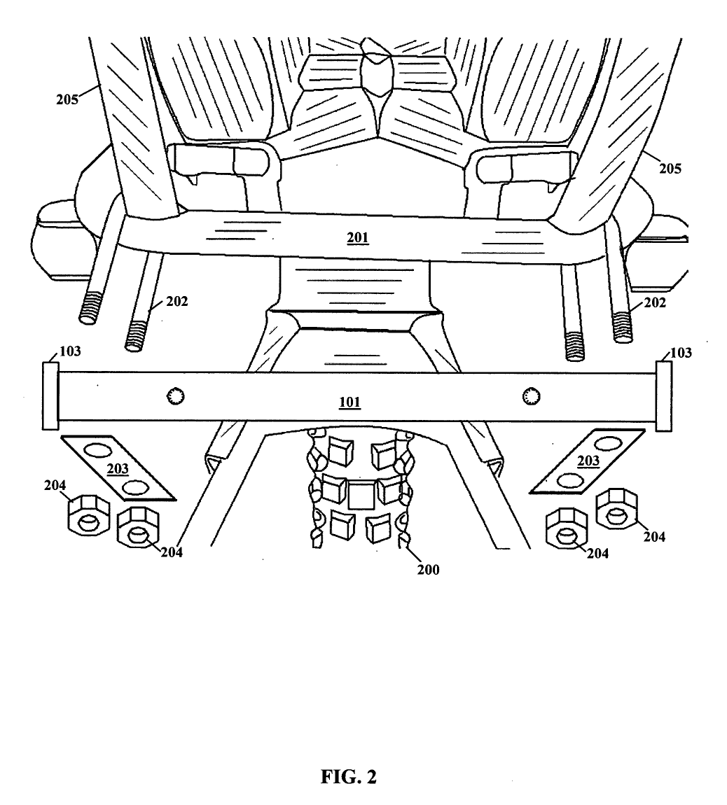

FIG. 2 illustrates a means for attaching the invention described with reference to FIG. 1, to a motorcycle or motorbike. The figure provides a view of coupler 101 from underneath the vehicle, looking toward the rear major wheel 200. The figure shows a vehicle frame having a cross-member 201 and frame arms 205 that are substantially perpendicular to cross-member 201. Cross-member 201 has curved portions that connect with frame arms 205. Cross-member 201 may comprise a portion of the vehicle's frame or a non-supporting member, such as a footbar. Preferably, cross-member 201 comprises a portion of the vehicle frame.

Coupler 101 is secured to cross-member 201 using U-bolts 202. A U-bolt 202 is placed around cross-member 201, on the outside of each frame arm 205. The elongated portion of coupler 101 is placed between the threaded arms of each U-bolt 202. The arms of each U-bolt 202 are placed through plates 203 and are received by nuts 204. Nuts 204 are tightened until plates 203 hold coupler 101 securely and immovably to cross-member 201. The ends 103 of coupler 101 are wider than the space between the arms of U-bolts 202, such that ends 103 remain outside of U-bolts 202. Once coupler 101 is secured to the vehicle, the axles and wheel assemblies may be easily secured to and removed from it, as described with reference to FIG. 1.

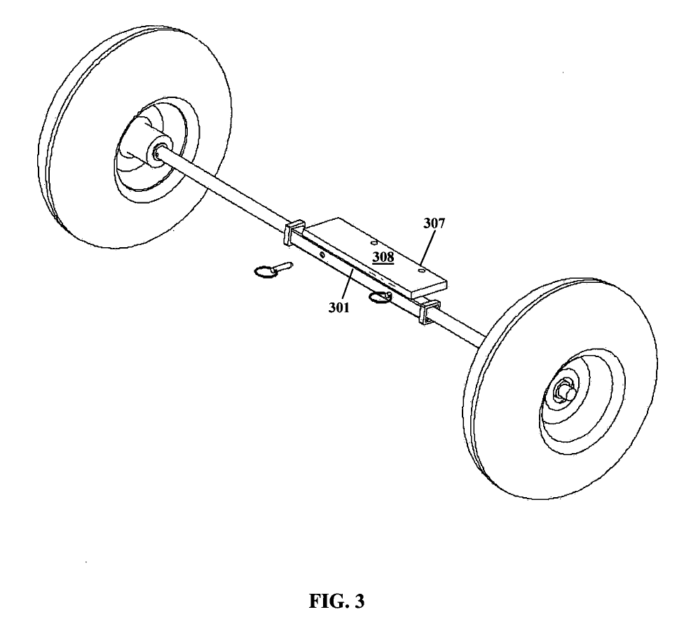

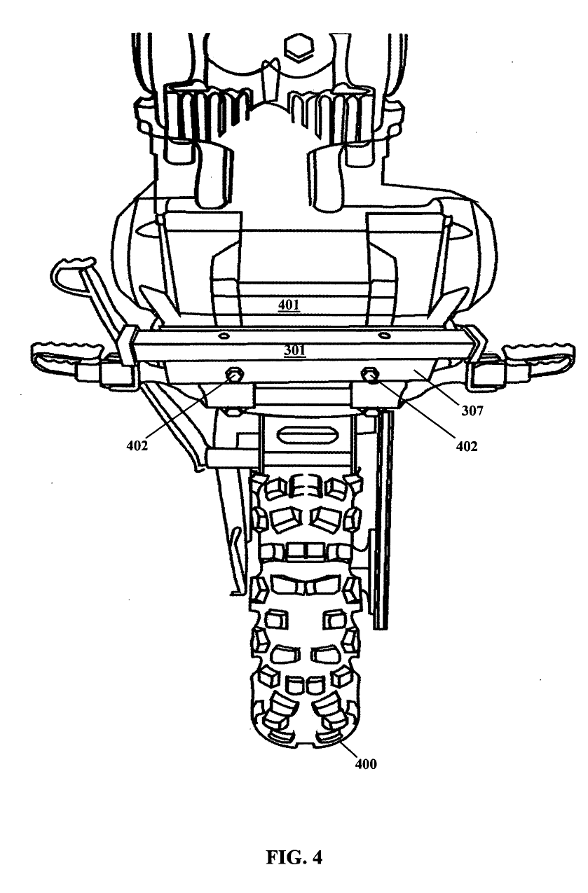

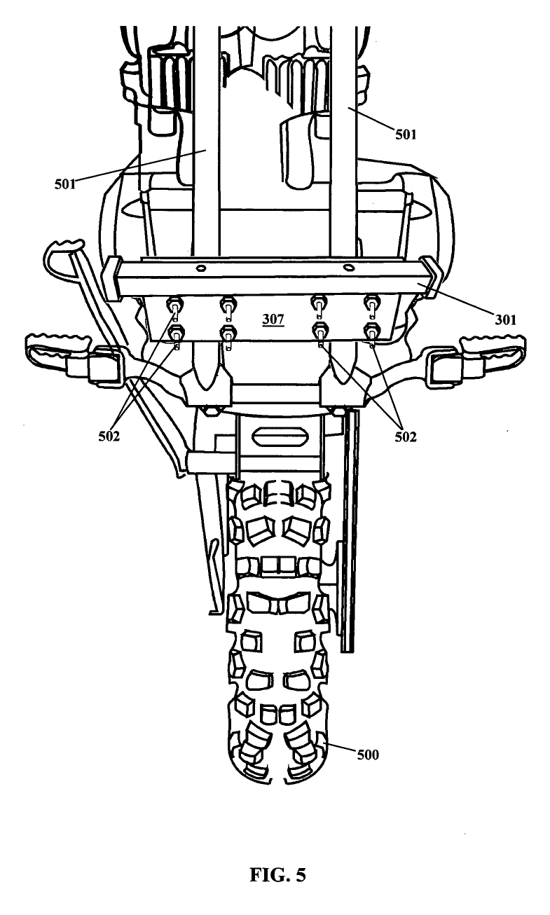

FIG. 3 illustrates a second embodiment of the current invention. The second embodiment is primarily for use with a vehicle that uses an engine, rather than a frame, as the backbone of its chassis. Nonetheless, it may also be used with a frame-supported vehicle, as described with reference to FIG. 5. The second embodiment of the invention is substantially the same as that described with reference to FIG. 1. Coupler 301 differs only in that it is integrally attached with a connector plate 307. Connector plate 307 extends perpendicularly to those surfaces of coupler 301 that contain the first and second pairs of holes for receiving fasteners 304. Connector plate 307 has at least one pair of holes extending through and perpendicular to its top surface 308. The holes are suited to receive means for attaching connector plate 307 to a vehicle engine casing, in the manner described with reference to FIG. 4, or to a frame, in the manner described with reference to FIG. 5.

Coupler 301 and connector plate 307 may comprise a unitary piece, or connector plate 307 may be welded onto coupler 301. Preferably, coupler 301 and connector plate 307 are welded together, such that the dimensions of connector plate 307 may be customized to fit specific vehicles. Because coupler 301 must be attached with connector plate 307, coupler 301 is preferably formed with rectangular sides in this second embodiment of the invention. The placement of holes on coupler 301 and the manner of attaching axles 305 with coupler 301 via fasteners 304 is the same as that described with reference to FIG. 1.

FIG. 4 illustrates the invention described with reference to FIG. 3, as it is attached to the engine casing of a motorcycle or motorbike. The figure provides a view of coupler 301 from underneath the vehicle, looking toward the rear major wheel 400 of the vehicle. FIG. 4 shows a vehicle engine casing 401. A footpeg bracket is attached with engine casing 401 by a pair of forward bolts nearest to the front major wheel of the vehicle and a pair of rear bolts nearest to the rear major wheel of the vehicle, as readily known by those skilled in the art. A brushguard may also be connected with the vehicle via either or both pair of these bolts.

Coupler 301 is secured to engine casing 401 by removing one of the pairs of bolts that attach the footpeg bracket to engine casing 401. Preferably, the pair of forward bolts are removed. The holes of connector plate 307 are aligned with those of the footpeg bracket, from which the pair of bolts were removed. Bolts 402 are then driven or threaded through the holes of connector plate 307, through the holes of the footpeg bracket, and into the holes of engine casing 401 that received the pair of bolts removed from the footpeg bracket. Preferably, bolts 402 are used in conjunction with locking washers that are placed between connector plate 307 and the footpeg bracket attached to engine casing 401. Bolts 402 are tightened until connector plate 307 is securely and immovably attached to engine casing 401. Bolts 402 may comprise the pair of forward bolts that were removed, if they are long enough to accommodate the thickness of connector plate 307. Preferably, bolts 402 do not comprise the pair of forward bolts that were removed. Preferably, connector plate 307 is attached such that coupler 301 extends toward the front major wheel of the vehicle and connector plate 307 extends toward the rear major wheel of the vehicle. Once the position of coupler 301 is fixed, the axles and wheel assemblies of the invention may be attached and detached, in the manners described with reference to FIG. 1.

FIG. 5 illustrates the invention described with reference to FIG. 3, as it is attached to the frame of a motorcycle or motorbike. The figure provides a view of coupler 301 from underneath the vehicle, looking toward the rear major wheel 500. As stated previously, connector plate 307 may have more than one pair of holes. Where connector plate 307 is attached with a vehicle frame, it preferably contains two or four pairs of holes. Most preferably, it contains four pair of holes.

The vehicle has two frame arms 501 substantially parallel with each other and with the orientation of the major wheels. Connector plate 307 is secured to frame arms 501 via U-bolts, the arms of which are shown at 502. Where connector plate 307 contains two pair of holes, a U-bolt may be placed around each frame member 501. The arms 502 of each U-bolt are then placed through a pair of holes on connector plate 307 and secured with nuts, as shown. Where connector plate 307 contains four pairs of holes, as shown in FIG. 5, two U-bolts are placed about each frame arm 501, and the arms 502 of each U-bolt are placed through a pair of holes on connector plate 307. Connector plate 307 is then secured to frame arms 501, by tightening the nuts on the U-bolts until the position of connector plate 307 along frame arms 501 remains fixed. Plates similar to those shown in FIG. 2 (at 203) may also be placed between the nuts on the arms 502 of the U-bolts and connector plate 307. Once the position of coupler 301 is fixed, the axles and wheel assemblies of the invention may be attached and detached, in the manners described with reference to FIG. 1.

Both embodiments of the invented apparatus are preferably of dimensions, such that the training wheels do not contact the ground when the vehicle is upright. In this way, a rider may progressively gain balance and control over the vehicle even when the training wheels are deployed. The training wheels still provide support while turning and when the vehicle is at rest.

The advantages of the disclosed invention will be readily appreciated by those skilled in the art. The coupler can remain securely fixed to the vehicle, without significantly increasing the dimensions or weight of the vehicle. The axles and wheel assemblies are easily removable and deployable, such that they may be removed during transport and storage of the vehicle and deployed for operation of the vehicle. This also allows for spot testing riders on their readiness to operate the vehicle without the wheel assemblies. The use of two axles provides additional advantages, by allowing the training wheels to be adjusted toward and away from the vehicle, unlike single-axle apparatuses.

The invention is also directed to a deployable training wheels kit for use with a vehicle having a front major wheel, a rear major wheel, and a supporting means, comprising the elements described with reference to the figures. The kit comprises two axles and a hollow coupler having two ends. Each axle has a proximal end and a distal end, and the coupler has an inner dimension sufficient for receiving the distal end of an axle at each end of the coupler. The kit also comprises at least two fasteners for removably securing the axles within the coupler, according to the manner described previously. The kit also comprises two wheel assemblies and means for rotatably attaching the wheel assemblies with the axles. Such means will be readily apparent to those skilled in the art. The kit also comprises at least two bolts for removably attaching the coupler with the vehicle supporting means, in the manners described previously, such that the wheel assemblies are disposed in parallel relation to the major wheels.

The kit may be used with vehicles whose supporting means comprise vehicle frames or engine casings. Where the vehicle supporting means comprises an engine casing, the coupler may also comprise a connector plate for attaching the coupler to the engine casing. The coupler and axles included in the kit may be susceptible of attachment at single or multiple positions.

The kit may also include at least one set of instructions, the manner of providing which will be readily appreciated by those skilled in the art. Each set of instructions may comprise instructions for using the kit with a frame-supported vehicle and instructions for using the kit with an engine-supported vehicle. Alternatively, each set of instructions may comprise instructions for using the kit only with a frame-supported vehicle or only with an engine-supported vehicle.

Those skilled in the art will appreciate that some elements of the invention may be varied without departing from the scope of the invention. For example, the fasteners used to secure the axles inside the coupler and the bolts used to secure the coupler to the vehicle are not critical to the invention, so long as they provide the degree of attachment disclosed herein. Additionally, the footpeg bracket may be entirely removed when securing the second embodiment of the invention to a vehicle's engine casing. These and other variations will be obvious to those skilled in the art.

What is claimed is:

1. A deployable training wheels apparatus for a vehicle having a front major wheel, a rear major wheel, and a supporting means, comprising:
a hollow coupler having two ends;
two axles, each axle having a proximal end and a distal end;
the distal end of each axle removably inserted into an end of the coupler;
each axle removably secured within the coupler by a fastener;
the proximal end of each axle rotatably attached with a wheel assembly; and
the coupler removably attached with the vehicle supporting means, such that the wheel assemblies are disposed in parallel relation to the major wheels.

2. The deployable training wheels apparatus of claim 1, wherein the vehicle supporting means comprises a vehicle frame.

3. The deployable training wheels apparatus of claim 1, wherein the vehicle supporting means comprises a vehicle engine casing.

4. The deployable training wheels apparatus of claim 2, wherein the coupler further comprises a connector plate for attaching coupler to the vehicle frame.

5. The deployable training wheels apparatus of claim 3, wherein the coupler further comprises a connector plate for attaching coupler to the vehicle engine casing.

6. The deployable training wheels apparatus of claim 1, wherein the vehicle further comprises a footbar attached with the supporting means, and wherein the coupler is removably attached with the footbar, such that the wheel assemblies are disposed in parallel relation to the major wheels.

7. The deployable training wheels apparatus of claim 1, wherein each axle may be secured within the coupler at a single position.

8. The deployable training wheels apparatus of claim 1, wherein each axle may be secured within the coupler at multiple positions.

9. The deployable training wheels apparatus of claim 1, wherein
the coupler further comprises at least one pair of coupler holes, each pair of coupler holes penetrating a surface of the coupler;
each axle further comprises at least one axle hole having a centerpoint that penetrates a diameter of the axle;
the coupler holes are aligned with the axle holes; and
each fastener is inserted through the coupler holes and the axle holes.

10. A deployable training wheels apparatus for a vehicle having a front major wheel, a rear major wheel, a supporting means and a footbar, comprising:
a hollow coupler having two ends;
two axles, each axle having a proximal end and a distal end;
the distal end of each axle removably inserted into an end of the coupler;
each axle removably secured within the coupler by a fastener;
the proximal end of each axle rotatably attached with a wheel assembly; and
the coupler removably attached with the footbar, such that the wheel assemblies are disposed in parallel relation to the major wheels.

11. A deployable training wheels kit for use with a vehicle having a front major wheel, a rear major wheel, and a supporting means, comprising:
a hollow coupler having two ends;
two axles, each axle having a proximal end and a distal end;
the coupler having an inner dimension sufficient for receiving the distal end of an axle at each end of the coupler;
at least two fasteners for removably securing the axles within the coupler;
two wheel assemblies;
means for rotatably attaching each wheel assemblies with an axles; and
at least two bolts for removably attaching the coupler with the vehicle supporting means, such that the wheel assemblies are disposed in parallel relation to the major wheels.

12. The deployable training wheels kit of claim 11, wherein the vehicle supporting means comprises a vehicle frame.

13. The deployable training wheels kit of claim 11, wherein the vehicle supporting means comprises a vehicle engine casing.

14. The deployable training wheels kit of claim 12, wherein the coupler further comprises a connector plate for attaching coupler to the vehicle frame.

15. The deployable training wheels kit of claim 13, wherein the coupler further comprises a connector plate for attaching coupler to the vehicle engine casing.

16. The deployable training wheels kit of claim 11, wherein the vehicle further comprises a footbar attached with the supporting means, and wherein the coupler is removably attached with the footbar, such that the wheel assemblies are disposed in parallel relation to the major wheels.

17. The deployable training wheels kit of claim 11, wherein each axle may be secured within the coupler at a single position.

18. The deployable training wheels kit of claim 11, wherein each axle may be secured within the coupler at multiple positions.

19. The deployable training wheels kit of claim 11, further comprising at least one set of assembly instructions.

20. The deployable training wheels kit of claim 11, wherein
the coupler further comprises at least one pair of coupler holes, each pair of coupler holes penetrating a surface of the coupler;
each axle further comprises at least one axle hole having a centerpoint that penetrates a diameter of the axle;
the coupler holes are aligned with the axle holes; and
each fastener is inserted through the coupler holes and the axle holes.
